(19) United States
(12) Patent Application Publication
(10) Pub. No.: US 2024/0193710 A1
(43) Pub. Date: Jun. 13, 2024

(54) INFORMATION PROCESSING APPARATUS, MANAGEMENT SYSTEM, AND INFORMATION PROCESSING METHOD

(71) Applicant: TOSHIBA TEC KABUSHIKI KAISHA, Tokyo (JP)

(72) Inventor: Isao Takahashi, Fuji Shizuoka (JP)

(21) Appl. No.: 18/329,604

(22) Filed: Jun. 6, 2023

(30) Foreign Application Priority Data
Dec. 9, 2022 (JP) 2022-196860

(51) Int. Cl. G06Q 50/12

(52) U.S. Cl. CPC G06Q 50/12

(57) ABSTRACT

The information processing apparatus manages an order in coordination with an order-receiving terminal that receives the order of a customer in a store and a kitchen terminal that notifies a cooking place of the order received by the order-receiving terminal via a communication device in the store, and includes a communication unit, an acquisition unit, and a conversion unit. The communication unit is communicably connected to a server that stores an order received by an external service not connected to the communication device in the store. The acquisition unit acquires the order received by the external service from the server via the communication unit. The conversion unit converts the order acquired by the acquisition unit into a format conforming to an order based on the order-receiving terminal and transmits the converted order to the kitchen terminal.

### CROSS-REFERENCE TO RELATED APPLICATION

This application is based upon and claims the benefit of priority from Japanese Patent Application No. 2022-196860, filed on Dec. 9, 2022, the entire contents of which are incorporated herein by reference.

### FIELD

An exemplary embodiment described herein relates to an information processing apparatus, a management system, and an information processing method.

### BACKGROUND

In the related art, in a restaurant or the like, a management system including an order-receiving terminal such as a handy terminal, a kitchen terminal installed in a cooking place, an order station that includes the order-receiving terminal and the kitchen terminal, and the like is widely used. On the other hand, in recent years, an external service that receives an order via cloud is popular. Store staff is notified of the order reception based on the external service via, for example, a dedicated terminal provided by an operation side of the service to a contract store.

The dedicated terminal is not included in the above-described management system used in the related art. Therefore, in a store where the management system is adopted, in order to transfer information on an order based on the external service to the management system to transmit the information to the cooking place, work in which a clerk visually checks the dedicated terminal and inputs the order by the handy terminal is generated.

If display of the dedicated terminal of the external service can be confirmed in the cooking place, or the clerk who visually checks the dedicated terminal can send a voice message to the cooking place, the task of transmitting the information to the cooking place is unnecessary. However, even in this case, in a case of the store where the management system is adopted, for convenience of sharing information on a merchandise situation (an inventory situation, an out-of-stock state, and order reception possible/impossible), work of inputting the order based on the external service has to be done at any timing.

In the coordination with the external service, it is not preferable that the number of parts to be changed to the existing system is increased. This is because, although it is cheaper than replacing with a completely new system, the more changed parts there are, the higher the cost and the higher the price, and therefore the store side is difficult to make a decision on introduction. Further, the more changed parts there are, the higher the risk of malfunctions occurring. Further, if a flow of an operation or a user interface (UI) is changed, a cost of re-education of the clerk may also be required. For the above reasons, it is desirable to preserve the existing system as much as possible to implement the coordination.

Coordination among a plurality of different systems is described, but a specific method for solving the problems described above is not provided.

### DESCRIPTION OF THE DRAWINGS

FIG. 1 is a diagram showing an example of connection between a configuration of a management system according to an embodiment and outside;

FIG. 2 is a diagram showing an example of a hardware configuration of a user terminal;

FIG. 3 is a diagram showing an example of a hardware configuration of an order station;

FIG. 4 is a diagram showing an example of a data configuration of a store information table;

FIG. 5 is a diagram showing an example of a data configuration of a merchandise management table;

FIG. 6 is a diagram showing an example of a data configuration of an order management table;

FIG. 7 is a block diagram showing an example of a functional configuration of a control unit;

FIG. 8 is a diagram illustrating a flow of information on an order via an external service and a transmission method for the information; and

FIG. 9 is a diagram illustrating a flow of transmission and reception and processing of information among apparatuses.

### DETAILED DESCRIPTION

In general, according to one embodiment, an information processing apparatus, a management system, and an information processing method that can take in an order received by an external service while preventing an influence on an existing system are provided.

An information processing apparatus according to an embodiment is for managing an order in coordination with an order-receiving terminal configured to receive the order of a customer in a store and a kitchen terminal configured to notify a cooking place of the order received by the order-receiving terminal via a communication device in the store, and includes a communication unit, an acquisition unit, and a conversion unit. The communication unit is configured to be communicably connected to a server configured to store an order received by an external service not connected to the communication device in the store. The acquisition unit is configured to acquire the order received by the external service from the server via the communication unit. The conversion unit is configured to convert the order acquired by the acquisition unit into a format conforming to an order based on the order-receiving terminal and to transmit the converted order to the kitchen terminal.

### (Configuration)

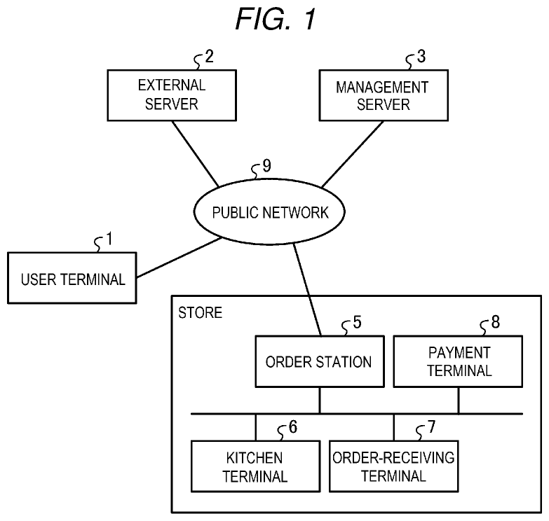

An embodiment will be described with reference to the drawings. FIG. 1 is a diagram showing an example of connection between a configuration of a management system according to the embodiment and outside. A user terminal 1, an external server 2, and a management server 3 exist outside the management system. The management system includes an order station 5, a kitchen terminal 6, an order-receiving terminal 7, and a payment terminal 8.

The user terminal 1, the external server 2, the management server 3, and the order station 5 are communicably connected using a public network (public line) 9. At the time of communication via the public network 9, encryption and virtual private network (VPN) connection are used as necessary.

The order station 5, the kitchen terminal 6, the order-receiving terminal 7, and the payment terminal 8 are apparatuses used in a store, and are apparatuses continuously used from a related-art management system. These apparatuses 5 to 8 are communicably connected to one another by a communication device in the store such as a local area network (LAN).

The user terminal 1 is, for example, a terminal apparatus such as a smartphone or a personal computer (PC) possessed by a customer.

The external server 2 is a server managed by an operation side of a service (external service) that receives an order via a cloud, and stores and manages information on the order and payment received from the user terminal 1 of the customer who uses an external service. The management also includes sharing (transmitting and receiving) information with the management server 3.

In addition to a delivery service and a takeout reservation, the external service described above includes an in-store mobile order. The delivery service is a service that delivers merchandise of a restaurant to outside of the restaurant. The takeout reservation is a service that receives a reservation for taking the merchandise of the restaurant out. Further, the in-store mobile order is a service that receives an order for merchandise to be eaten or drank in the store from the user terminal 1 possessed by the customer.

The store described in the present embodiment does not have to contract all the external services described above, and the store selects and uses the external services as necessary.

The management server 3 is an example of a server, and performs data coordination between the external server 2 and the store. More specifically, an order via the external service is acquired from the external server 2.

The order station 5 is an example of an information processing apparatus, performs the data coordination among the kitchen terminal 6, the order-receiving terminal 7, and the payment terminal 8, and manages these terminals 6 to 8. Specifically, the order station 5 transmits information on an order received from the order-receiving terminal 7 to the kitchen terminal 6, and transmits information on the order or payment as a response to an inquiry from the payment terminal 8. In the data coordination and the management described above, the order station 5 communicates with the terminals 6 to 8 by socket communication, memory sharing, or the like.

The order station 5 shares information between the management server 3 and the store. Specifically, the order station 5 transmits information on an order or payment made in the store to the management server 3, and acquires information on an order or payment via the external service from the management server 3. Communication between an apparatus outside the store such as the management server 3 and the store is solely handled by the order station 5. Other terminals 6 to 8 in the store do not communicate with the apparatuses outside the store.

The kitchen terminal 6 is, for example, a kitchen display or a kitchen printer, and notifies cooking place staff of information. The notification is performed by a screen display, printout, or sound output. Information output from the kitchen terminal 6 is, for example, content of an order. Further, the kitchen terminal 6 receives an input of information such as completion of cooking.

The order-receiving terminal 7 is, for example, a handy terminal or a table order terminal. The handy terminal is used by a clerk, and receives an input of an order from the customer in the store. The table order terminal is installed at a table or the like, and is used for inputting an order by the customer himself/herself.

The payment terminal 8 is, for example, a point of sales (POS) terminal, is installed in the store, and performs processing related to the order or the payment according to an operation performed by an operator. POS terminals include a fully self-checkout terminal and a semi-self-checkout terminal in addition to a most common POS terminal on the assumption that the clerk performs an operation related to merchandise registration (order) and settlement. The fully self-checkout terminal receives the order and the settlement based on a customer operation. The semi-self-checkout terminal receives an operation related to settlement of merchandise registered by the clerk from the customer.

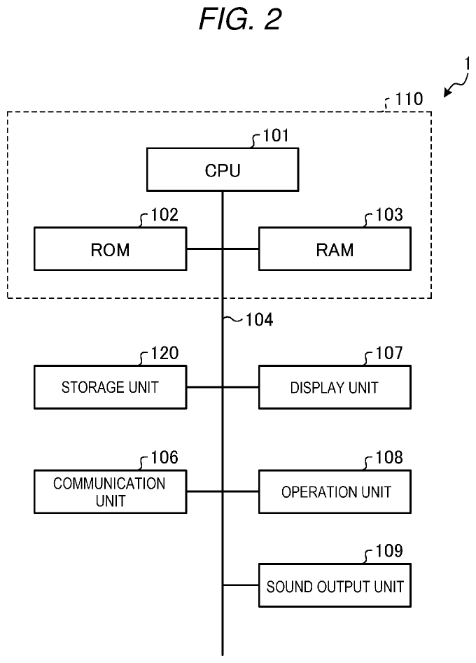

FIG. 2 is a diagram showing an example of a hardware configuration of the user terminal 1. The user terminal 1 includes a central processing unit (CPU) 101, a read only memory (ROM) 102, and a random access memory (RAM) 103.

The CPU 101 is an example of a processor, and comprehensively controls an act of the user terminal 1. The ROM 102 stores various programs. The RAM 103 is a workspace for loading programs and various kinds of data. The CPU 101, the ROM 102, and the RAM 103 are connected to one another via a bus 104, and constitute a control unit 110 having a computer configuration. In the control unit 110, the CPU 101 executes various kinds of processing by performing an act according to a program stored in the ROM 102 or a storage unit 120 and loaded into the RAM 103.

The control unit 110 is connected to the storage unit 120 and a communication unit 106 via the bus 104. The storage unit 120 is implemented by a hard disk drive (HDD), a flash memory, or the like, and maintains stored content even if a power supply is cut off. The storage unit 120 stores various programs to be executed by the CPU 101, and various kinds of setting information on an act of the user terminal 1. For example, the storage unit 120 stores an application program related to a display of merchandise information provided from the external server 2.

The communication unit 106 is a communication interface that can be connected to the public network 9. The communication unit 106 communicates with the external server 2 and the like via the public network 9.

A display unit 107, an operation unit 108, a sound output unit 109, and the like are connected to the control unit 110 via the bus 104.

The display unit 107 is a display device such as a liquid crystal display (LCD), and displays various kinds of information under control of the control unit 110. The display unit 107 is implemented by, for example, a touch panel display.

The operation unit 108 includes various operation keys, and outputs key information corresponding to an operation of the operator to the control unit 110. The operation unit 108 includes a touch panel provided on a display surface of the display unit 107.

The sound output unit 109 is a sound output device such as a speaker, and outputs a sound under control of the control unit 110.

The hardware configuration of the user terminal 1 is not limited to the example in FIG. 2. For example, if the user terminal 1 is a smartphone, the user terminal 1 includes a sound input unit such as a microphone or an imaging unit such as an image sensor.

Hardware configurations of the kitchen terminal 6, the order-receiving terminal 7, and the payment terminal 8 are also substantially similar to that of the example shown in FIG. 2. That is, each of the terminals 6 to 8 also includes the communication unit, the display unit, the operation unit, the sound output unit, the storage unit, and the like, and achieves a respective function by the control unit comprehensively controlling the above-described units.

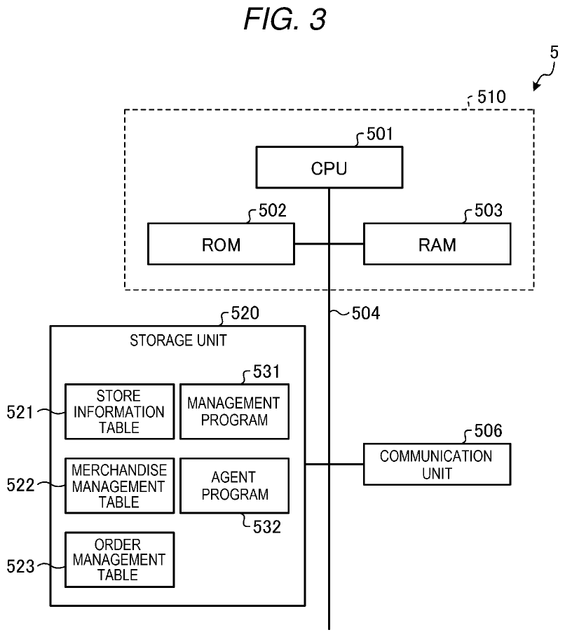

FIG. 3 is a diagram showing an example of a hardware configuration of the order station 5. The order station 5 includes a CPU 501, a ROM 502, and a RAM 503.

The CPU 501 is an example of a processor, and comprehensively controls an act of the order station 5. The ROM 502 stores various programs. The RAM 503 is a workspace for loading programs and various kinds of data. The CPU 501, the ROM 502, and the RAM 503 are connected to one another via a bus 504, and constitute a control unit 510 having a computer configuration. In the control unit 510, the CPU 501 executes various kinds of processing by performing an act according to a program stored in the ROM 502 or a storage unit 520 and loaded into the RAM 503.

The control unit 510 is connected to the storage unit 520 and a communication unit 506 via the bus 504. The storage unit 520 is implemented by the HDD, the flash memory, or the like, and maintains stored content even if the power supply is cut off. The storage unit 520 stores various programs to be executed by the CPU 501, and various kinds of setting information on an act of the order station 5. Further, the storage unit 520 stores a store information table 521, a merchandise management table 522, an order management table 523, and the like.

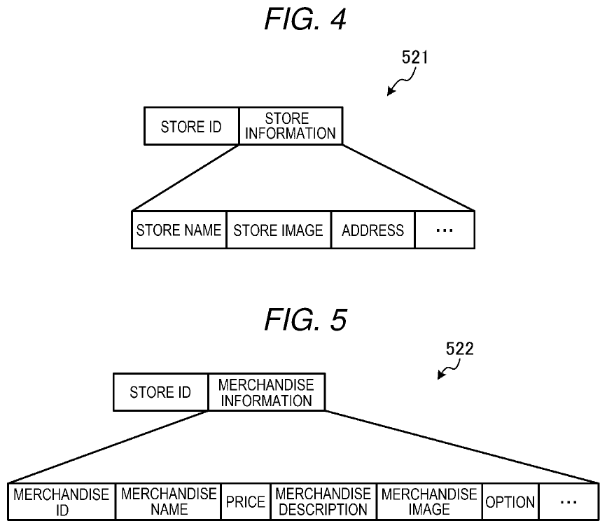

The store information table 521 stores information on stores. FIG. 4 is a diagram showing an example of a data configuration of the store information table 521. The store information table 521 stores store information on a store corresponding to a store ID in correlation with the store ID for identifying each store.

The store information includes, for example, items such as a store name, a store image, and an address. Here, the store name is information indicating a name, a shop name, an abbreviation, or the like of the store. The store image is image data representing a store such as a logo mark or a store name of the store. The address is contact information. The contact information may be a telephone number or an address, or may be information on communication with the order station 5 such as an IP address or a host name of the order station 5.

The merchandise management table 522 stores information on merchandise handled by a plurality of stores. FIG. 5 is a diagram showing an example of a data configuration of the merchandise management table 522. The merchandise management table 522 stores information on merchandise (merchandise information) sold in a store corresponding to a store ID in correlation with a store ID of each store.

The merchandise information is implemented by, for example, items such as a merchandise ID, a merchandise name, a price, a merchandise description, a merchandise image, and an option. The merchandise ID is identification information for identifying each merchandise. The merchandise name is information indicating a name or an abbreviation of merchandise. The price is information indicating a price per merchandise. The merchandise description stores various kinds of information on the merchandise. For example, the merchandise description stores information on ingredients included in the merchandise, a cooking time required for cooking.

The merchandise image is image data representing merchandise. The option is information added if a serving amount such as “large serving”, a topping, or the like can be specified.

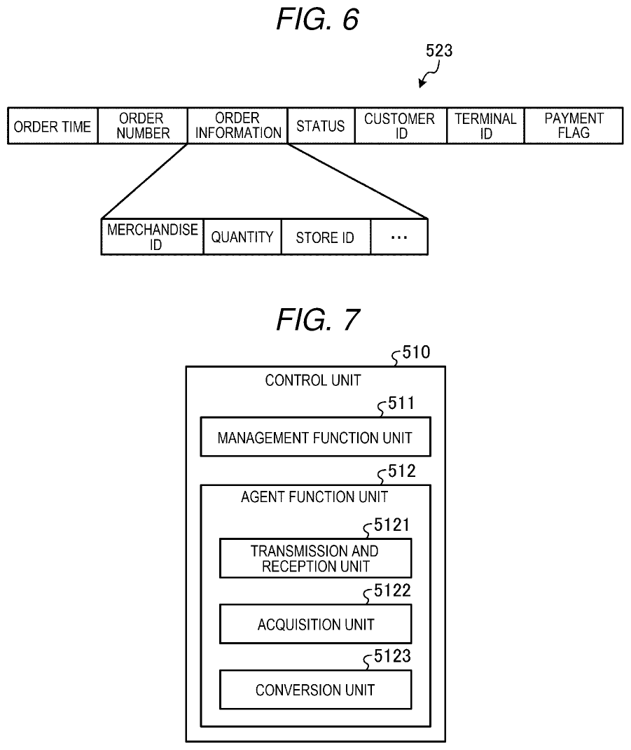

The order management table 523 stores order information. The order information is information on an order for merchandise stored in the merchandise management table 522. FIG. 6 is a diagram showing an example of a data configuration of the order management table 523. The order management table 523 stores information such as an order time, an order number, order information, a status, a customer ID, a terminal ID, and a payment flag in correlation with one another. The order management table 523 according to the present embodiment also stores order information via the external service in addition to order information input by the order-receiving terminal 7 in the store.

Here, the order time is date and time information indicating date and time on which the order station 5 receives the order information. Further, the order number is number information indicating an order in which the order information is received. For example, numbers in ascending order are given in an order of receiving the order information. The order information includes a merchandise ID and a quantity of merchandise to be ordered, a store ID of a store that sells the merchandise, and the like.

The status is status information indicating a state of the order information. The status stores a current state among states of a plurality of stages from order reception to delivery of the merchandise. Here, the status includes the states of the plurality of stages from the order reception to the delivery of the merchandise. For example, states such as “new” indicating a state immediately after the order reception, “in cooking” indicating that the merchandise is in cooking, “completion of cooking” indicating a state where the cooking is completed, “in calling” indicating that a customer who orders the merchandise for the takeout reservation is called, “in delivery” indicating that a delivery person of the delivery service is in the middle of carrying the merchandise, and “completion of delivery” indicating that the merchandise is in a state of being delivered to the customer are stored.

The customer ID is an ID given to a customer registered as a member of the store. Further, the terminal ID is terminal information of the user terminal 1 of a transmission source.

The payment flag indicates whether payment related to an order of an order number correlated with the payment flag is completed. The payment flag according to the present embodiment takes a value of either one of “0” and “1”. The value “0” of the payment flag indicates that the payment is not completed, and the value “1” indicates that the payment is completed. In the present embodiment, the payment flag is updated from “0” to “1” depending on whether the customer performs a payment operation with the user terminal 1 possessed by the customer himself/herself or the clerk performs a settlement operation with the payment terminal 8 in the store.

The storage unit 520 further stores programs such as a management program 531 and an agent program 532.

The communication unit is a communication 506 interface that can be connected to the public network 9. The communication unit 506 communicates with the management server 3 and the like via the public network 9.

FIG. 7 is a block diagram showing an example of a functional configuration of the control unit 510. The management program 531 is a program for providing a related-art function (transmission of information on an order in the store) of the order station 5. The order station 5 functions as a management function unit 511 similar to that of the related art by the control unit 510 executing the management program 531. The management function unit 511 achieves the related-art function of managing the terminals 6 to 8. That is, by executing the management program 531, the control unit 510 acquires an order input to the order-receiving terminal 7 in the store, causes the kitchen terminal 6 to output information on a new order, and updates a payment flag of the order settled by the payment terminal 8.

The agent program 532 is a new program for causing the management function unit 511 to coordinate with the external service. The control unit 510 functions as an agent function unit 512 by executing the agent program 532. The agent function unit 512 includes a transmission and reception unit 5121, an acquisition unit 5122, and a conversion unit 5123.

When there is a change in the information on the order in the store, the transmission and reception unit 5121 transmits and receives information for sharing the change with the management server 3. The information is transmitted and received via the communication unit 506 and the public line. For example, the transmission and reception unit 5121 transmits the order received by the order-receiving terminal 7 and information on payment of the order to the management server 3. Further, if receiving the status (for example, “in cooking” or “completion of cooking”) indicating a progress situation of cooking of the received order from the kitchen terminal 6, the transmission and reception unit 5121 transmits the status to the server.

The acquisition unit 5122 acquires an order received by the external server 2 not connected to the communication device in the store and stored in the management server 3 from the management server 3 via the communication unit 506 and the public line.

Since information of an order acquired by the management server 3 from the external server 2 is information in a format determined by the external service, the information does not necessarily coincide with a data format of the management system in the store. Therefore, the conversion unit 5123 converts the information on the order acquired by the acquisition unit 5122 into a format conforming to an order based on the order-receiving terminal 7, and transmits the converted information to the kitchen terminal 6. Accordingly, in the management function unit 511 that implements the management system in the store, the order via the external service can be handled similarly to the order based on the order-receiving terminal 7 without change.

The external server 2 and the management server 3 basically also have a hardware configuration including the communication unit, the storage unit, the control unit, and the like in a substantially similar manner as in the example shown in FIG. 3, and achieve respective functions by the control unit executing a program stored in the storage unit.

The storage unit of the management server 3 stores information similar to the information stored in the store information table, the merchandise management table, and the order management table of the order station 5. However, only the information on the store where the order station 5 is installed is written in each table stored by the order station 5, whereas the storage unit of the management server 3 stores information on the plurality of stores.

A format of the information stored in the management server 3 is not necessarily the same as that of the order station 5. However, in the present embodiment, in order to simplify the description, it is assumed that the management server 3 includes a table group (the store information table, the merchandise management table, the order management table) corresponding to the tables provided in the order station 5.

The management server 3 provides an application programming interface (WebAPI) that can be used from other apparatuses other than the management server 3. For example, in response to an inquiry (request) specifying a store ID, the WebAPI provided by the management server 3 transmits (responses) a record of order information whose status is “new” among records corresponding to the store ID in the order management table of the management server 3. The acquisition unit 5122 of the agent function unit 512 of the order station 5 uses the WebAPI described above.

Another WebAPI provided by the management server 3 responds to, for example, a request for updating or adding the order information. Specifically, if receiving information in which an order number and a store ID are specified and the status or the payment flag is updated, the WebAPI described above updates a status or a payment flag of a record corresponding to the order number and the store ID in the order management table of the WebAPI according to the information. Further, if receiving information of a new order number, the WebAPI correlates the information with a store ID of a transmission source, and adds the information to the order management table of the WebAPI. The transmission and reception unit 5121 of the agent function unit 512 of the order station 5 uses the WebAPI described above.

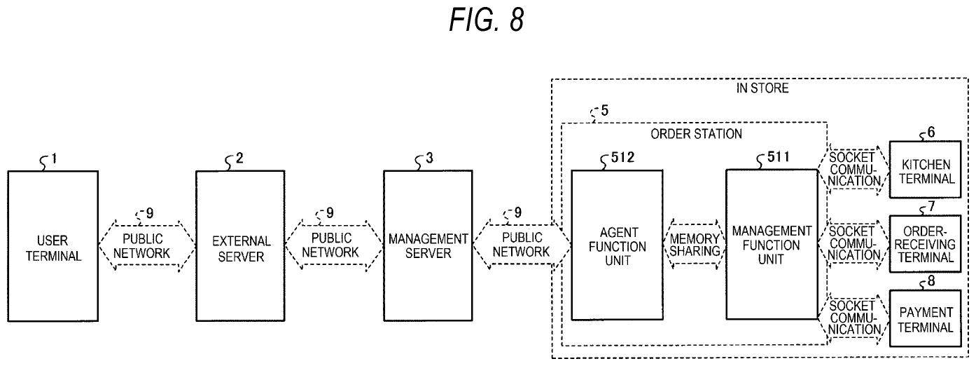

FIG. 8 is a diagram illustrating a flow of the information on the order via the external service and a transmission method for the information. If the user terminal 1 orders merchandise in a store via the external service, the user terminal 1 and the external server 2 communicate with each other via the public network 9. If the order based on the external service is generated, the external server 2 transmits information on the order to the management server 3 via the public network 9.

The management server 3 stores the information on the order received from the external server 2 in the order management table of the storage unit. Further, the management server 3 communicates with the agent function unit 512 of the order station 5 via the public network 9.

The agent function unit 512 mediates communication between the management function unit 511 and the management server 3, and matches information between the management function unit 511 and the management server 3. That is, order information increased in the management server 3 is transmitted to the management function unit 511, and order information increased in the order station 5 is transmitted to the management server 3. Further, order information updated in the order station 5 (for example, information on the status or the payment flag) is transmitted to the management server 3.

Since both the agent function unit 512 and the management function unit 511 are function units provided in the order station 5, communication between the agent function unit 512 and the management function unit 511 is performed by the memory sharing. The communication may be implemented by the socket communication. Further, communication between the management function unit 511 and the kitchen terminal 6, the order-receiving terminal 7, and the payment terminal 8 is performed using a method similar to that of the related art, and for example, is performed using the socket communication.

### (Flow of Processing)

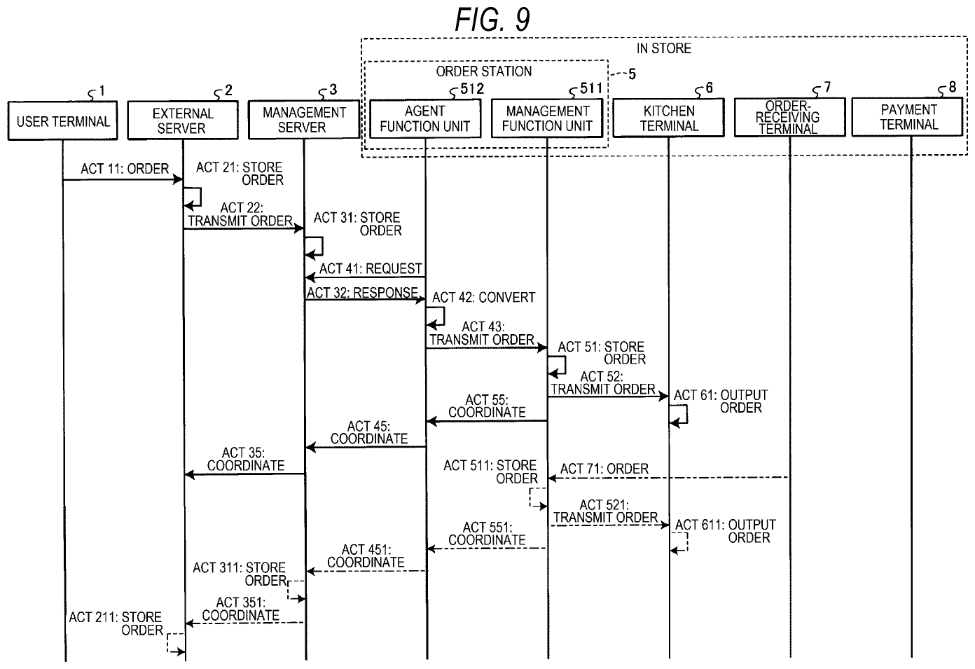

In such a configuration, the apparatuses perform transmission and reception and processing of information by using a flow shown in FIG. 9. FIG. 9 is a diagram illustrating the flow of the transmission and reception and the processing of the information among the apparatuses.

First, an example of the delivery service that is one of the external services will be described. Processing related to the takeout reservation is substantially similar to that of the delivery service. Processing related to the in-store mobile order is substantially similar to that of the delivery service unless an order from the order-receiving terminal 7 in the store is used in combination.

If the processing related to the in-store mobile order and the order from the order-receiving terminal 7 are used in combination, since there is a part where a state is different from those of other services, the different part will be separately described later.

If a customer who uses the delivery service performs an operation of ordering merchandise of a store by using the user terminal 1, the user terminal 1 transmits information on the order to the external server 2 (Act 11). The external server 2 that receives the information stores the information on the order (Act 21), and then transmits the information on the order to the management server 3 (Act 22). If receiving the information on the order from the external server 2, the management server 3 stores the information in the order management table of the storage unit (Act 31).

The agent function unit 512 periodically transmits a request to the management server 3 (Act 41), and obtains a response (Act 32). In Act 41, the agent function unit 512 specifies a store ID of a store where the agent function unit 512 (order station 5) is installed, and requests a record (information) whose status is “new” from the order management table. In Act 32, the management server 3 transmits a record that matches the request. For example, management may be performed using a flag in the management server 3 such that the response to the request does not include a record already stored in the order station 5.

The agent function unit 512 converts the information on the order received from the management server 3 into a format conforming to an order based on the order-receiving terminal 7 (Act 42), and transmits the converted information to the management function unit 511 (Act 43). Accordingly, the management function unit 511 can handle the order from the external service in a similar manner as the information received from the order-receiving terminal 7.

The management function unit 511 causes the order management table 523 of the storage unit 520 to store the information on the order received from the agent function unit 512 (Act 51). Next, the management function unit 511 transmits the information on the order to the kitchen terminal 6 (Act 52). The kitchen terminal 6 outputs the information on the order by the screen display or the printout (Act 61).

Further, the management function unit 511 coordinates with the agent function unit 512 on a fact that the order is transmitted to the kitchen terminal 6 (Act 55). The agent function unit 512 performs similar coordination with the management server 3 (Act 45), and the management server 3 performs similar coordination with the external server 2 (Act 35). If the order is a first order, a fact that check-in is performed in Act 51 and the check-in is completed in Acts 55, 45, and 35 is also coordinated.

If an operation of changing the status to “in cooking” or “completion of cooking” is input from the kitchen terminal 6, the kitchen terminal 6 outputs a signal to the order station 5. If the order station 5 receives the signal from the kitchen terminal 6, content indicated by the signal is coordinated with the management server 3 and the external server 2 in a flow conforming to Acts 55, 45, and 35.

In the information coordination in Act 55, the management function unit 511 acts on the agent function unit 512 in the above-described description, but for example, the following can be considered in order to avoid changing the act of the management function unit 511 from a related-art one during execution.

For example, on an agent function unit 512 side, by confirming the memory used by the management function unit 511 for the order storage (Act 51) at an appropriate timing, the act of the management function unit 511 may be grasped, and the order coordination (Act 55) may be performed. According to the above, the information on the order can be coordinated by the action from the agent function unit 512 without changing the act of the management function unit 511 from the related-art one.

### (Combined Use of Services)

Next, an act if the customer uses the in-store mobile order that is one of the external services, and the order from the order-receiving terminal 7 in the store is used in combination will be described. In this description, parts common to those described above will be omitted, and different parts will be described.

The in-store mobile order is an operation of giving a printout of a two-dimensional code including identification information and order site information to a seated customer and receiving an order input from the user terminal 1 possessed by the customer. In the operation, the customer accesses and logs in an order site by causing the user terminal 1 to read the two-dimensional code, and performs an operation related to an order for merchandise via a graphical user interface (GUI) provided by the external service. A flow of transmission and reception and processing of information if the customer uses the user terminal 1 to use the in-store mobile order is similar to those of Acts 11 to 35 already described.

If a customer who has an order history via the in-store mobile order places an order via the order-receiving terminal 7 in the store, the management server 3 shares information on the order in the store with the external server 2 for convenience of payment. The flow of the transmission and reception and the processing of the information in this case (Acts 71 to 211 in FIG. 9) is as described below.

If receiving an input of the information on the order, the order-receiving terminal 7 transmits the information to the order station 5 (Act 71). If the order station 5 receives the information from the order-receiving terminal 7, the management function unit 511 causes the order management table 523 of the storage unit 520 to store the information on the order received from the order-receiving terminal 7 (Act 511).

Next, the management function unit 511 transmits the information on the order to the kitchen terminal 6 (Act 521). The kitchen terminal 6 outputs the information on the order by the screen display or the printout (Act 611). The processing of Acts 71 to 611 is similar to processing in a related-art system in which the order station 5 does not include the agent function unit 512.

Next, the management function unit 511 coordinates with the agent function unit 512 for order content from the order-receiving terminal 7 (Act 551). The agent function unit 512 performs similar coordination with the management server 3 (Act 451). The management server 3 causes the storage unit of the management server 3 to store the information on the order (Act 311), and performs similar coordination with the external server 2 (Act 351). The external server 2 causes the storage unit of the external server 2 to store the information on the order (Act 211). Accordingly, the order in the store is also coordinated with the management server 3 and the external server 2.

For the information coordination in Act 551, as in Act 55, on the agent function unit 512 side, the act of the management function unit 511 may be grasped by confirming the memory used by the management function unit 511 for the order storage (Act 511) at an appropriate timing.

The order in the store is shared with the external server 2 by the flow of the transmission and reception and the processing of the information described above (Acts 71 to 211 in FIG. 9).

As described above, according to the agent function unit 512 of the present embodiment, the order station 5 of the store can share the information with the management server 3 that bundles the information on the store that uses the external service. Accordingly, if the external service, which is popular in recent years, receives an order from the user terminal 1 via the cloud, it is possible to eliminate work of re-inputting the order to the order-receiving terminal 7 (or the payment terminal 8) while visually checking a dedicated terminal for the external service, which has to be done in the related art.

Also in the operation of the in-store mobile order that is popular in recent years, according to the present embodiment, as described above, the information on the order input from the user terminal 1 can be taken into the related-art management system via the external server 2 and the management server 3.

The program executed by each apparatus according to the embodiment described above is provided by being incorporated in advance in the ROM or the like. The program executed by each apparatus according to the embodiment described above may be provided by being recorded in a computer-readable recording medium such as a CD-ROM, a flexible disk (FD), a CD-R, or a digital versatile disk (DVD) as a file having an installable format or an executable format.

Further, the program executed by each apparatus according to the embodiment described above may be stored in a computer connected to a network such as the Internet, and provided by being downloaded via the network. Further, the program executed by each apparatus according to the embodiment described above may be provided or distributed via the network such as the Internet.

Although certain exemplary embodiments are described, these embodiments are presented as examples only, and are not intended to limit the scope of the exemplary embodiments. These novel embodiments can be executed in various other forms, and various omissions, substitutions, changes, and combinations can be made within a scope not departing from the gist of the exemplary embodiment. The accompanying claims and their equivalents are intended to cover such forms or modifications as would fall within the scope and spirit of the exemplary embodiments.

What is claimed is:

1. An information processing apparatus for managing an order in coordination with an order-receiving terminal configured to receive the order of a customer in a store and a kitchen terminal configured to notify a cooking place of the order received by the order-receiving terminal via a communication device in the store, the information processing apparatus comprising:
a communication component configured to be communicably connected to a server configured to store an order received by an external service not connected to the communication device in the store;
an acquisition component configured to acquire the order received by the external service from the server via the communication component; and
a conversion component configured to convert the order acquired by the acquisition component into a format conforming to the order-receiving terminal and to transmit the converted order to the kitchen terminal.

2. The information processing apparatus according to claim 1, wherein
the external service is at least any one of a service of receiving a delivery of merchandise provided by a store to outside of the store, a service of receiving a takeout reservation of merchandise provided by the store, and a service of receiving an order for merchandise provided in the store from a terminal possessed by a customer.

3. The information processing apparatus according to claim 1, wherein
if the acquisition component receives information of a new order number, the kitchen terminal correlates the information with a store ID of a transmission source, and adds the information to an order management table.

4. The information processing apparatus according to claim 1, further comprising:
a transmission and reception component configured to transmit a status indicating a progress situation of the order to the server if receiving the status from the kitchen terminal.

5. The information processing apparatus according to claim 1, wherein the status is at least one of “new order”, “in cooking”, and “completion of cooking”.

6. The information processing apparatus according to claim 1, wherein the communication component is communicably connected to the server via a LAN.

7. The information processing apparatus according to claim 1, wherein the communication component is communicably connected to the server wirelessly.

8. A management system, comprising:
an order-receiving terminal configured to receive an order of a customer in a store;
a kitchen terminal configured to notify a cooking place of the order received by the order-receiving terminal;
an information processing apparatus configured to manage the order in coordination with the order-receiving terminal and the kitchen terminal via a communication device in the store;
a communication component configured to be communicably connected to a server configured to store an order received by an external service not connected to the communication device in the store;
an acquisition component configured to acquire the order received by the external service from the server via the communication component; and
a conversion component configured to convert the order acquired by the acquisition component into a format conforming to the order-receiving terminal and to transmit the converted order to the kitchen terminal.

9. The management system according to claim 8, wherein
the external service is at least any one of a service of receiving a delivery of merchandise provided by a store to outside of the store, a service of receiving a takeout reservation of merchandise provided by the store, and a service of receiving an order for merchandise provided in the store from a terminal possessed by a customer.

10. The management system according to claim 8, wherein
if the acquisition component receives information of a new order number, the kitchen terminal correlates the information with a store ID of a transmission source, and adds the information to an order management table.

11. The management system according to claim 8, further comprising:
a transmission and reception component configured to transmit a status indicating a progress situation of the order to the server if receiving the status from the kitchen terminal.

12. The management system according to claim 11, wherein the status is at least one of “new order”, “in cooking”, and “completion of cooking”.

13. The management system according to claim 8, wherein the communication component is communicably connected to the server via a LAN.

14. The management system according to claim 8, wherein the communication component is communicably connected to the server wirelessly.

15. An information processing method for a management system comprising an order-receiving terminal configured to receive an order of a customer in a store, a kitchen terminal configured to notify a cooking place of the order received by the order-receiving terminal, and an information processing apparatus configured to manage the order in coordination with the order-receiving terminal and the kitchen terminal via a communication device in the store, the information processing method comprising:
communicably connecting to a server configured to store an order received by an external service not connected to the communication device in the store;
acquiring the order received by the external service from the server via a communication component; and
converting the acquired order into a format conforming to the order-receiving terminal and transmitting the converted order to the kitchen terminal.

16. The information processing method according to claim 15, wherein
the external service is at least any one of a service of receiving a delivery of merchandise provided by a store to outside of the store, a service of receiving a takeout reservation of merchandise provided by the store, and a service of receiving an order for merchandise provided in the store from a terminal possessed by a customer.

17. The information processing method according to claim 15, further comprising:
receiving information of a new order number;
correlating the information with a store ID of a transmission source; and
adding the information to an order management table.

18. The information processing method according to claim 15, further comprising:
transmitting a status indicating a progress situation of the order to the server if receiving the status from the kitchen terminal.

19. The information processing method according to claim 18, wherein the status is at least one of “new order”, “in cooking”, and “completion of cooking”.

20. The information processing method according to claim 15, further comprising wirelessly connecting to the server.
